(19) United States
(12) Patent Application Publication
(10) Pub. No.: US 2004/0027376 A1
(43) Pub. Date: Feb. 12, 2004

(54) Displaying information over multiple user interface (UI) views

(76) Inventors: Dale E. Calder, Mansfield, MA (US); Alan Goldman, Holliston, MA (US)

Correspondence Address: FISH & RICHARDSON PC, 225 FRANKLIN ST, BOSTON, MA, 02110, US

(21) Appl. No.: 10/214,939

(22) Filed: Aug. 8, 2002

(51) Int. Cl. G09G 5/00

(52) U.S. Cl. 345/755; 345/767

(57) ABSTRACT

A method of displaying data over a plurality of user interface (UI) views, includes receiving an input reference time, initializing a time on a UI view within the reference time and preserving the reference time across a plurality of views. The method can also include initializing each UI view with data corresponding to a predetermined time from the reference time.

A method of displaying information includes receiving information from an information source. The information includes multiple types of information. The method also includes storing the information in a database and displaying the information in a user interface. The information is presented in a multiple views where each view corresponds to one or more types of information and each view has a corresponding time reference value. The method further includes receiving a time value from the user through the user interface and setting the time reference value for each view equal to the time value selected by the user.

### TECHNICAL FIELD

This disclosure relates to displaying information in a user interface.

### BACKGROUND

A monitoring system contains historical information collected from different types of sources e.g., a software system, equipment, etc. For example, the monitoring system can track the performance of a generator, a pump or monitor a database. The historical information can include data collected over time, discrete events such as alarms, actions, and notes. For example, the data collected may be continuous temperature readings or central processing unit (CPU) usage or readings taken at varying time intervals. Each data point is related to a timestamp. Discrete events occur at a single point in time. An alarm, for instance, includes a timestamp along with a description, severity, and value. A note is text entered at a certain time by an operator. An action, for example, may be to turn a motor off or start a new process. The history contained in the monitoring system is a sequence of data, alarms, notes, and actions, each with its own timestamp.

The information is presented to a user using multiple views because no single view satisfies every user's needs. Data can be displayed in a chart with a time range. Graphical displays that resemble a dashboard or control panel show the state of data at a particular time. Discrete events are typically lists of alarms, actions, etc.

Heretofore, when a user had multiple views of different kinds of information, a prior art UI required the user to search through each piece of information. For example, if something unusual happened in a generator's data yesterday, the user would search back through the alarms to determine what happened to the generator at the time the generator failed. Then, the user would search back through notes made by the maintenance team, and other types of events individually to determine what happened at that time. Each time the user accessed a view, the user would search for that moment in time when the generator failed. Thus, in the prior art, the views of data, alarms, notes, actions are not tied together by a single time. The user had to search through each kind of information to piece together the whole picture.

### SUMMARY

In one aspect, the invention is a method of displaying data over a plurality of user interface (UI) views. The method includes receiving an input reference time, initializing a time on a UI view within the reference time and preserving the reference time across a plurality of views.

This aspect may include one or more of the following features. The reference time is input using an input/output device. The reference time is input by selecting an object having a time component with a mouse. The reference time is input by typing the reference time on a keyboard. The method may include initializing each UI view with data corresponding to a predetermined time from the reference time. The method may include highlighting data corresponding to the reference time. The method may include highlighting data within a predetermined time from the reference time. The method may include publishing the views using a hypertext transfer protocol (HTTP) web server. The method may include storing a unique reference time for each multiple hypertext transfer protocol (HTTP) user sessions. The method may include retrieving from a database data corresponding to the reference time.

In another aspect, the invention is an apparatus that includes a memory that stores executable instructions for displaying data over a plurality of user interface (UI) views; and a processor. The processor executes instructions to receive an input reference time, to initialize a time on a UI view within the reference time, and to preserve the reference time across a plurality of views.

This aspect may contain one or more of the following features. The reference time is input using an input/output device. The reference time is input by selecting an object having a time component with a mouse. The reference time is input by typing the reference time on a keyboard. The processor executes instructions to initialize each UI view with data corresponding to a predetermined time from the reference time. The processor executes instructions to highlight data corresponding to the reference time. The processor executes instructions to highlight data within a predetermined time from the reference time. The processor executes instructions to publish the views using a hypertext transfer protocol (HTTP) web server. The processor executes instructions to store a unique reference time for each multiple hypertext transfer protocol (HTTP) user sessions. The processor executes instructions to retrieve from a database data corresponding to the reference time.

In a still further aspect, the invention is an article that includes a machine-readable medium that stores executable instructions for displaying data over a plurality of user interface (UI) views. The instructions cause a machine to receive an input reference time, initialize a time on a UI view within the reference time, and preserve the reference time across a plurality of views.

This aspect may contain one or more of the following features. The reference time is input using an input/output device. The reference time is input by selecting an object having a time component with a mouse. The reference time is input by typing the reference time on a keyboard. The instructions cause the machine to initialize each view with data corresponding within a predetermined time from the reference time. The instructions cause the machine to highlight data corresponding to the reference time. The instructions cause the machine to highlight data within a predetermined time from the reference time. The instructions cause the machine to publish the views using a hypertext transfer protocol (HTTP) web server. The instructions cause the machine to store a unique reference time for each multiple hypertext transfer protocol (HTTP) user sessions. The instructions cause the machine to retrieve from a database data corresponding to the reference time.

In another aspect, the invention is a method of displaying information. The method includes receiving information from an information source. The information includes multiple types of information. The method also includes storing the information in a database and displaying the information in a user interface. The information is presented in a multiple views where each view corresponds to one or more types of information and each view has a corresponding time reference value. The method further includes receiving a time value from the user through the user interface and setting the time reference value for each view equal to the time value selected by the user.

One or more of the aspects above have one more of the following advantages. By preserving the reference time over multiple UI views, a user does not need to set the reference time each time the user changes a view. Thus, the user can navigate through the views to focus on key areas of the information without extra actions on the user's part. Also, by highlighting data or graphing data before and after a chosen time reference, the user can see the status of a failed device including the events prior to the failure and the events after failure. Thus, synchronizing the reference time for each view allows the user to navigate between views of different information (or different views of the same information) without losing context.

### DESCRIPTION OF THE DRAWINGS

FIG. 1 is a block diagram of a monitoring system.

FIG. 2 is a block diagram of a Device Relationship Management system.

FIG. 3 is a process for preserving the time reference over multiple display views.

FIGS. 4A-4C are user interface views.

### DESCRIPTION

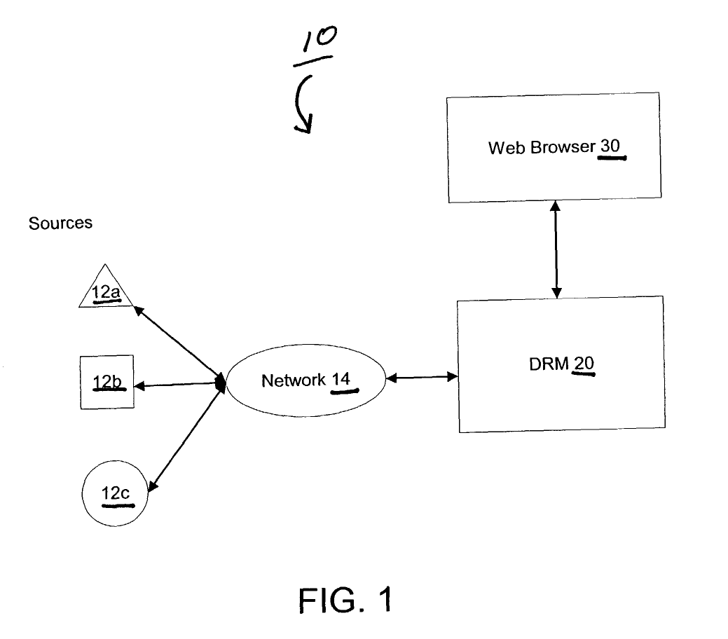

Referring to FIG. 1, a monitoring system 10 includes sources 12a, 12b and 12c, a network 14 (e.g., Internet), a device relationship management (DRM) system 20, and a web browser 30. Information is sent from sources 12a-12c through network 14 to DRM system 20. Sources 12a-12c may include equipment (e.g., pumps, generators, etc.), databases that store collected data (e.g., sales, production numbers, etc.), or applications servers or any combination thereof. As will be shown below, the information sent to DRM system 20 is accessed by a user interface (UI), such as web browser 30 that has multiple views of the information. When a user selects a reference time in one view, each view within the UI is initialized to that reference time so that the user can navigate the various views without resetting the time for each view that is subsequently accessed.

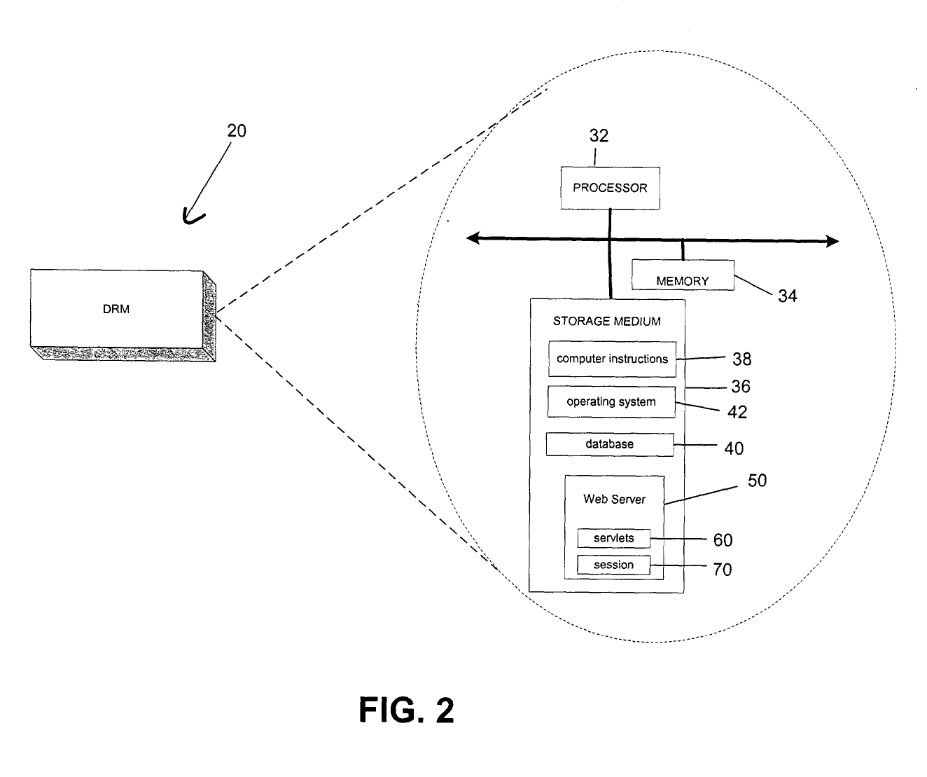

Referring to FIG. 2, DRM system 20 includes a processor 32, a memory 34 and a storage medium 36. Storage medium 36 includes computer instructions 38, a database 40, an operating system 42 and a web server 50. Database 40 stores each type of information received from sources 12a-12c in a table, e.g., data, alarms, notes, actions, and configuration. Each type of information also has an associated timestamp, which indicates the time of the event or the time the data was acquired. Web server 50 includes servlets 60 and a session 70. Each servlet generates one of the pages or views that a browser displays. Since each servlet is independent, the servlet uses session 70 to determine the current state. The user uses web browser 30 to access web server 50 to retrieve the information collected in database 40.

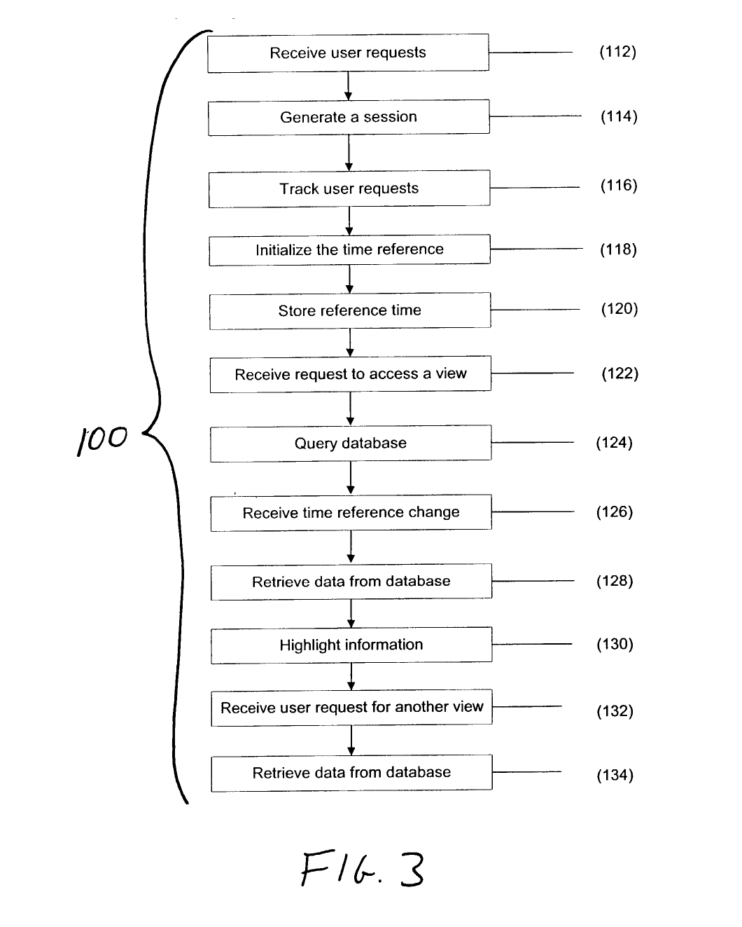

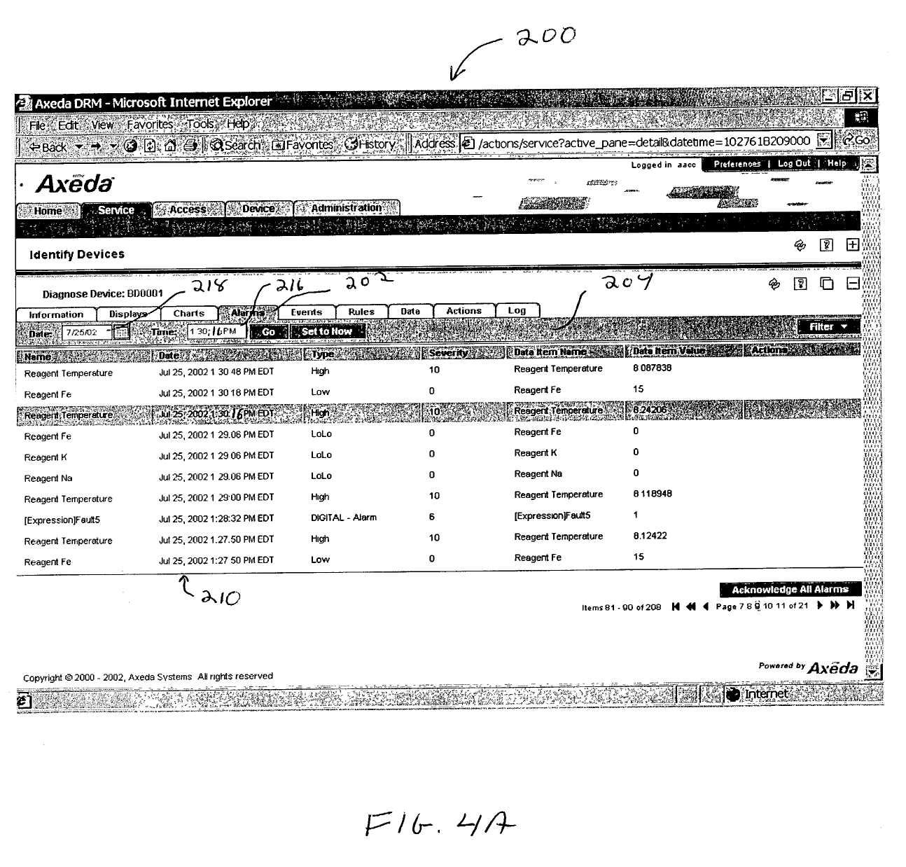

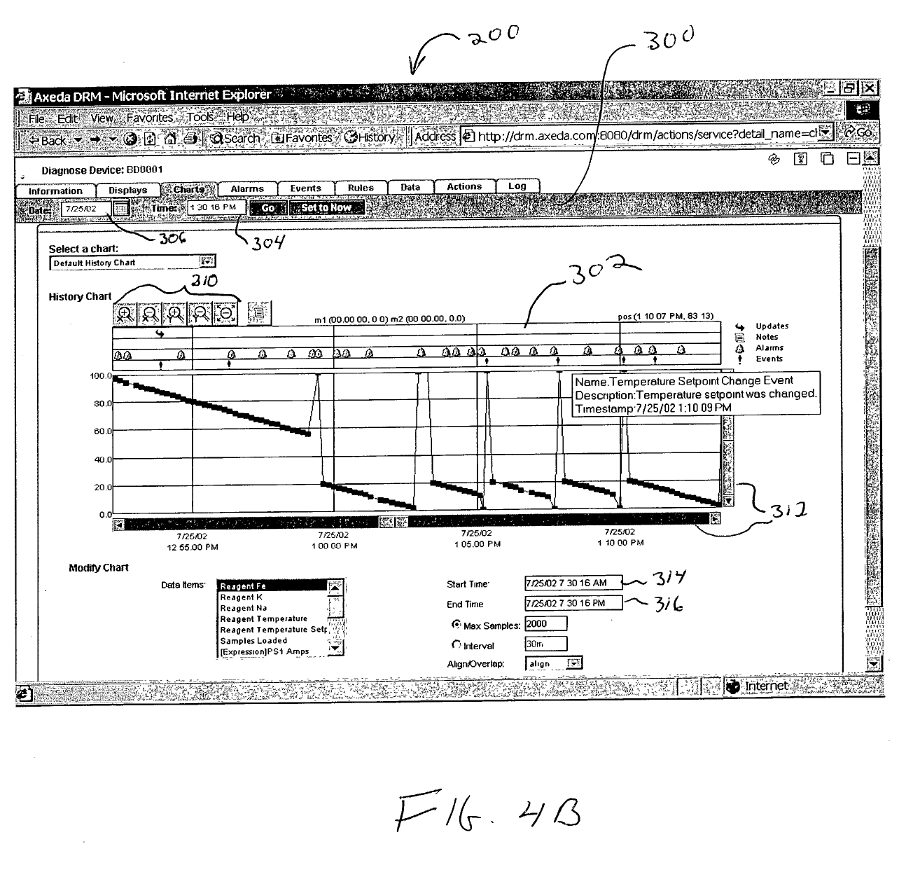

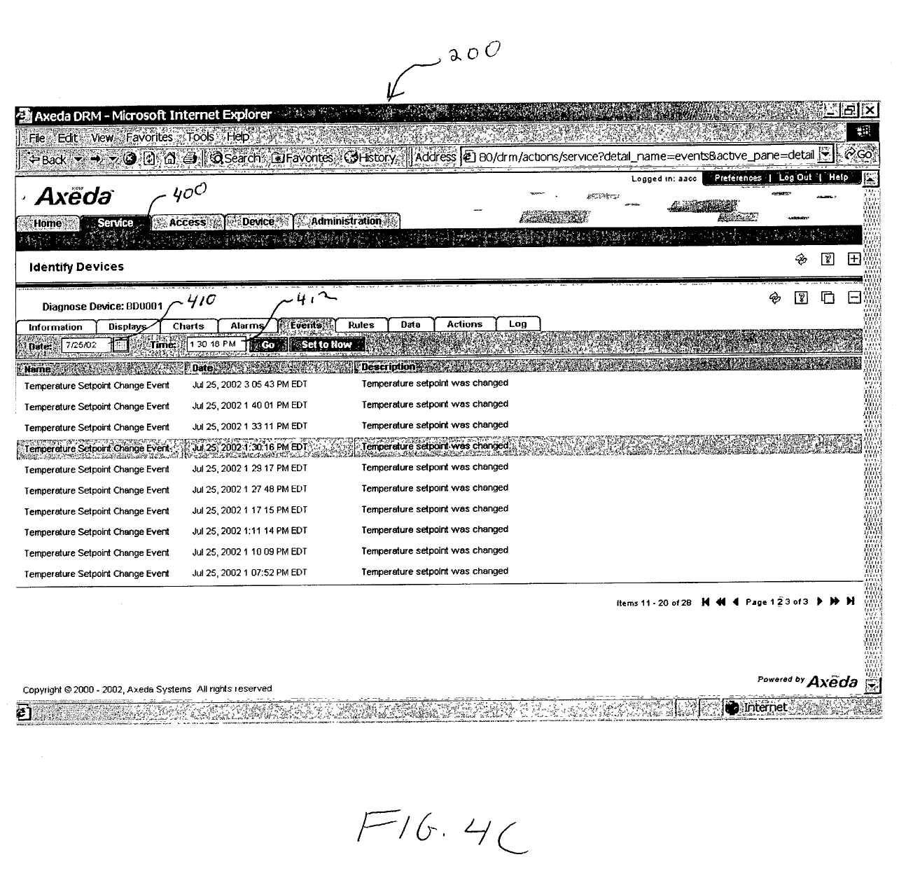

DRM system 20 publishes a web-based UI (not shown), viewable from web browser 30. The web UI includes multiple pages that have different views of the information. DRM system 20 allows a single reference time to be used to coordinate the views so that all of the information around that reference time can be viewed. DRM system 20 manages the web UI using an exemplary process 100, shown in FIG. 3. DRM 20 uses computer instructions 38 which are executed by processor 32 out of memory 34 to perform process 100 and thus to generate the user interfaces shown in FIGS. 4A to 4C.

Process 100 receives (112) a log-on request from the user at a DRM system website (not shown) on web server 50 and a request from the user to access the web page through a password access. The user initiates these requests through web browser 30. Process 100 generates (114) session 70 for each user accessing web server 50. In session 70, process 100 tracks (116) requests made by each user of monitoring system 10. Process 100 initializes (118) a reference time to the current time. Process 100 stores (120) the reference time in session 70. Process 100 receives (122) a request to access a view from the user. For example, the user clicks an alarm view tab 202 using a mouse interface on a web page 200 (FIG. 4A) to access an alarm view 204. Process 100 queries (124) database 40 for the relevant information for alarm view 204. The data that is displayed corresponds to the current time.

However, the user may choose to change the reference time. The user changes the time reference by selecting a field that contains a time stamp. Process 100 receives (126) the change in the time reference from the user and stores the change in session 70. Process 100 retrieves (128) the data that corresponds to the new reference time selected by the user. Process 100 highlights (130) the item in a list that corresponds to the new reference time.

Referring to FIG. 4A, for example, when the user goes to alarm view 204, web server 50 queries an alarm table in database 40 and formats the results into web page 200. Alarm view 204 includes an alarms list 210. Each line in alarm list 210 represents an alarm and is a link. When the user selects one of the alarms, the link sends another page request back to server 50. The same page will be displayed, but with the selected alarm highlighted 214 and the reference time set to the alarm time 214. The reference time is also changed in session 70. A time display 216 and a date display 218 are also updated to reflect the reference time. A user may select a time reference by selecting it, or the user may enter a reference time by typing it into time display 216 and date display 218.

Referring to FIG. 4B, process 100 receives (132) requests from the user to subsequently selected views, for example, a chart view 300 showing data in a chart 302. Process 100 retrieves (134) data from the database 40 for data over a selected time range around the reference time using server 70. For example, the time range may be a six hours centered on the reference time. A start display 314 indicates the start time six hours before the reference time and an end time display 316 indicates the end time six hours after the reference time. The data values are used to plot chart 302. The reference time is displayed in time display 304 and the date in date display 306.

In other embodiments, chart 302 includes options for the user to expand or narrow the time range using buttons 310, and to scroll forward and back using scroll bars 312. The actions of scrolling forward and back request the page again from server 50, and server 50 also updates the reference time.

Referring to FIG. 4C, if the user goes to a page of other events, such as notes or actions, server 50 will query database 40 and format a page with the relevant information. The reference time is used in the database query and formatted to only show information around that time, and to highlight the events close to the reference time (out of a list of events). For example, in the event view 400 there may be 28 events, but the table shows 10 per page. If the reference time matches the 14th event, the page is generated with the event table already set to page 2 of 3. In addition, a time display 412 and a date display 410 would already be set to the reference time. An event that matches the new reference time is highlighted. In other embodiments, events within 10 minutes, for example, of the reference time may be also highlighted with a less bold color.

In operation, a user uses monitor system 10 to find quick explanations for failures. For example, monitoring system 10 can be used to monitor vacuum pumps. If the user locates an alarm, the user selects that alarm for further inquiry. The user switches to a chart view, which will show historical data around the reference time (time of the alarm) selected by the user. For example, the view shows temperature, vacuum pressure, pump state, and the current operation. If the pressure is too high, for example, the user can then switch to a list of notes to see if anyone had recorded a seal problem.

The user can also look at a configuration view to see if any maintenance work has been done to affect the problem. For example, the user searches the configuration view for the text “seal” and finds the times that seals have been replaced. By selecting one of these configuration events and going to a data view, the user will see the chart of vacuum chamber variables. The next time the pump is turned on, the user sees the pressure rise time with a new seal. The user is able to compare the profile with the new seals to the current profile to look for degradation in performance.

Process 100 is not limited to use with the hardware and software of FIGS. 1 and 2; it may find applicability in any computing or processing environment and with any type of machine that is capable of running a computer program. Process 100 may be implemented in hardware, software, or a combination of the two. For example, process 100 may be implemented in a circuit that includes one or a combination of a processor, a memory, programmable logic and logic gates. Process 100 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 100 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 10. Process 100 may also be implemented as a machine-readable storage medium, configured with a computer program, where upon execution, instructions in the computer program cause the computer to operate in accordance with process 100.

The process is not limited to the specific embodiments described herein. For example, the server can generate pages with any web technology. The web page may be HTML or dynamic hypertext mark-up language (DHTML), and the web page can contain client side scripts and controls such as Java applets or ActiveX. The web page can generate graphics in a graphics “language” such as scalable vector graphics (SVG) or it can generate a picture in portable network graphics (PNG) format, graphics interchange format (GIF), and/or joint photographic experts group (JPEG) format. The process is not limited to the specific processing order of FIG. 3. Rather, the blocks of FIG. 3 may be re-ordered, as necessary, to achieve the results set forth above.

Other embodiments not described herein are also within the scope of the following claims.

What is claimed is:

1. A method of displaying data over a plurality of user interface (UI) views, comprising:
receiving an input reference time;
initializing a time on a UI view within the reference time; and
preserving the reference time across a plurality of views.

2. The method of claim 1, wherein the reference time is input using an input/output device.

3. The method of claim 2, wherein the reference time is input by selecting an object having a time component with a mouse.

4. The method of claim 2, where the reference time is input by typing the reference time on a keyboard.

5. The method of claim 1, further comprising:
initializing each UI view with data corresponding to a predetermined time from the reference time.

6. The method of claim 1, further comprising:
highlighting data corresponding to the reference time.

7. The method of claim 6, further comprising:
highlighting data within a predetermined time from the reference time.

8. The method of claim 1, further comprising:
publishing the views using a hypertext transfer protocol (HTTP) web server.

9. The method of claim 1, further comprising:
storing a unique reference time for each multiple hypertext transfer protocol (HTTP) user sessions.

10. The method of claim 1, further comprising:
retrieving from a database data corresponding to the reference time.

11. An apparatus comprising:
a memory that stores executable instructions for displaying data over a plurality of user interface (UI) views; and
a processor that executes the instructions to:
receive an input reference time;
initialize a time on a UI view within the reference time; and
preserve the reference time across a plurality of views.

12. The apparatus of claim 11, wherein the reference time is input using an input/output device.

13. The apparatus of claim 12, wherein the reference time is input by selecting an object having a time component with a mouse.

14. The apparatus of claim 12, where the reference time is input by typing the reference time on a keyboard.

15. The apparatus of claim 11, further comprising instructions to:
initialize each UI view with data corresponding to a predetermined time from the reference time.

16. The apparatus of claim 11, further comprising instructions to:
highlight data corresponding to the reference time.

17. The apparatus of claim 16, further comprising instructions to:
highlight data within a predetermined time from the reference time.

18. The apparatus of claim 11, further comprising instructions to:
publish the views using a hypertext transfer protocol (HTTP) web server.

19. The apparatus of claim 11, further comprising instructions to:
store a unique reference time for each multiple hypertext transfer protocol (HTTP) user sessions.

20. The apparatus of claim 11, further comprising instructions to:
retrieve from a database data corresponding to the reference time.

21. An article comprising a machine-readable medium that stores executable instructions for displaying data over a plurality of user interface (UI) views, the instructions causing a machine to:
receive an input reference time;
initialize a time on a UI view within the reference time; and
preserve the reference time across a plurality of views.

22. The article of claim 21, wherein the reference time is input using an input/output device.

23. The article of claim 22, wherein the reference time is input by selecting an object having a time component with a mouse.

24. The article of claim 22, where the reference time is input by typing the reference time on a keyboard.

25. The article of claim 21, further comprising instructions causing the machine to:
initialize each view with data corresponding within a predetermined time from the reference time.

26. The article of claim 21, further comprising instructions causing the machine to:
highlight data corresponding to the reference time.

27. The article of claim 26, further comprising instructions causing the machine to:
highlight data within a predetermined time from the reference time.

28. The article of claim 21, further comprising instructions causing the machine to:
publish the views using a hypertext transfer protocol (HTTP) web server.

29. The article of claim 21, further comprising instructions causing the machine to:
store a unique reference time for each multiple hypertext transfer protocol (HTTP) user sessions.

30. The article of claim 21, further comprising instructions causing the machine to:
retrieve from a database data corresponding to the reference time.

31. A method of displaying information, comprising:
receiving information from an information source, the information includes a plurality of types of information;
storing the information in a database;
displaying the information in a user interface, the information being presented in a plurality of views, each view corresponding to one or more types of information and each view having a corresponding time reference value;
receiving a time value from the user through the user interface; and
setting the time reference value for each view equal to the time value selected by the user.
